(19) United States
(12) Patent Application Publication
(10) Pub. No.: US 2008/0110025 A1
(43) Pub. Date: May 15, 2008

(54) Hair removal device and method for using the same

(76) Inventor: Louis R. Bucalo, Miami Beach, FL (US)

Correspondence Address: Sofer & Haroun, LLP, Suite 910, 317 Madison Avenue, New York, NY, 10017, US

(21) Appl. No.: 11/818,950

(22) Filed: Oct. 23, 2006

Related U.S. Application Data
(60) Provisional application No. 60/732,939, filed on Nov. 3, 2005.

(51) Int. Cl. B26B 19/00; B26B 21/00

(52) U.S. Cl. 30/43.1; 30/526; 30/32

(57) ABSTRACT

A device for removing hair from the back of an individual includes a substantially straight extension member and a handle coupled to a first upper end of the straight extension member. The handle has an adjustable angle relative to the substantially straight extension member. An adjustable razor member is coupled to the second lower end of the straight extension member, where the length of the substantially straight adjustable member is adjustable to a desired height on the back to be shaved, the angle of the handle, relative to the substantially straight extension member is adjustable, and the razor is adjustable to a desired position to an appropriate angle for contacting the individuals back at the desired height.

### RELATED APPLICATION

This application is related to, and claims the benefit of priority from U.S. Provisional Patent Application No. 60/732,939, filed on Nov. 3, 2005.

### FIELD OF THE INVENTION

The present invention relates generally to hair removal devices and methods, and more specifically, to devices and methods for removing hair from the back of an individual.

### BACKGROUND OF THE INVENTION

Many men have unwanted hair on their back that they would like to remove. Non-shaving methods of hair removal such as laser treatment, wax-based hair removal, and electrolysis treatment are available, but are costly and are not private to the individual, requiring the involvement of a service group and provider. In addition, the time necessary for scheduling, attending and performing such procedures is often considerable, making them unacceptable for many individuals.

The above factors greatly reduce the utility of such procedures for many men. Shaving of the hair on the back is another potential procedure, but effective, safe and convenient devices and methods for doing so without assistance have not been previously disclosed or developed.

Removal of hair on the back with traditional commercial razors for face or leg shaving is not possible to do without the assistance of another person, since such razors do not allow access to a major portion of the back by the individual, and require another person to assist in shaving the individual's back, making such devices unsuitable for many people who do not want to involve another person in this process.

Therefore, traditional face shaving razor devices do not provide a solution for removing unwanted hair on the back for individuals desiring to complete this task in private. In addition, and very importantly, such razors are intended to be used with, and function best when used on, shorter hairs that have been wetted with hot water and/or covered with a lather before shaving. This is necessary for such a razor to work properly, and to avoid irritation and cutting of the skin's outer layer, the epidermis, during shaving.

The requirement of lathering one's back prior to shaving it is clearly suboptimal and would require a separate device, or another individual's assistance, for this to be accomplished effectively for most areas of the back, limiting the utility of such conventional consumer razors and other shaving devices that teach or suggest the use of lather application to the skin area prior to shaving the back.

In addition, such conventional face razors and, therefore, any devices that contemplate employing them for back shaving, are intended to function properly when cutting shorter hairs requiring careful short stokes with reasonable amounts of pressure to the skin, and do not function as effectively on longer dense hairs, such as those that are often found on the back. Use of such conventional razors on long hairs of the back or chest, for example, is not very easy because the length of the hair interferes with the function of the razor, resulting in a need for even greater pressure against the skin and higher number of razor strokes in an area to be shaved.

Conventional face razors are made for cutting relatively short hairs and function by pinching the hair between the blade edge and the skin immediately behind the hair. The more pressure applied, the more skin is pushed up behind the blade and when the blade finally moves forward, there is greater potential for cutting the skin. There is not much margin for error in applying additional pressure when shaving the back, since the diameter of body hair, about 0.003 inches, is approximately the same as the thickness of the epidermis, the layer of outer skin that protects against infection.

The use of greater than normal pressure and greater number of shaving strokes increases the risk of irritation and cuts, which are already common in face shaving with such devices. Such irritation and cuts from face shaving are usually not significant or serious, because the damage that commonly occurs to the epidermis of the face from shaving can readily be treated with topical astringents, antiseptics and hemostasis agents to prevent significant bleeding or infection.

However, unlike the face, the skin of the back is not very easily routinely cared for, so repeated accidental irritation and cuts on the back are likely to lead to more significant problems such as bleeding and infection. Infection of the skin, such as folliculitis and cellulitis can be serious conditions, particularly if they occur in areas of the body that are difficult to routinely monitor, clean and treat by applying an antiseptic medication. Therefore, even a normal rate of bleeding and cutting of the skin of the back as experienced with face shaving razors and associated devices would be problematic on the skin of the back, and as described above, use of conventional shaving razors on the back would require techniques that could substantially increase this risk.

Therefore, it is not to be recommended that large number of individuals shave their backs unassisted using devices that comprise or employ consumer shaving razors or associated methods that employ them. It is important that any device or method for shaving the back specifically disclose a means to enable reduction of the potential for irritation and cutting of the epidermis, in order for the device to be enabling for use by most individuals without assistance.

It can be appreciated from the above that conventional consumer face or leg shaving razors, as are generally available in supermarkets, convenience stores and drug stores, are not preferable or properly enabling for removing hair from the back without assistance. In addition, previous devices and methods for back hair removal disclosed in the field that may employ, incorporate or teach use of such razors for self-shaving of the back, and incorporate or suggest associated procedures of wetting the back with hot water, or application of shaving cream to the back prior to shaving are not sufficiently convenient, efficient or safe to enable or promote wide spread use of such devices and methods. Such previously disclosed devices and methods do not do not reduce the risk of irritation, cutting of the epidermis and potential infection from such a procedure, do not allow most men to reach and effectively remove hair from substantially all areas of the back, and do not teach or enable use of an optimally safe and effective hair cutting device and method for such a procedure.

### OBJECTS AND SUMMARY

A device and method are needed which avoid the above problems and limitations. Specifically, a device and method are needed to allow substantially all men within normal human height variation to comfortably and effectively remove hair from the entire back without assistance, to do so without significant risk of irritation and cutting of the epidermis and associated problems of bleeding and infection, to not require the inconvenience of applying shaving cream, lather, or hot water to the back prior to shaving, and to effectively shave the back without applying excessive pressure of the blade to the skin for shaving areas of dense, longer hairs. Such solutions are provided by the current invention.

The current invention enables these objectives by utilizing, in one preferred embodiment, a specialized razor, called a hospital disposable razor or prep razor, to comprise the hair cutting member of the device. Alternatively, in another embodiment, a personal grooming, electric hair cutting device not intended for face shaving comprises the hair cutting member.

Prep razors generally have common characteristics that are directed at permitting the safe, effective, efficient cutting of longer body hair, such as that found on the back, without the need for significant pressure against the skin, excessive shaving strokes to adequately shave a given area with longer hair, wetting of the skin with hot water, or application of shaving cream to the skin. These characteristics include, but are not limited to, a skin reference means in front of the blade, which is often a comb-like piece with teeth immediately in front of the blade edge, with minimal spacing between the teeth to minimize the risk of skin riding up between the teeth to the blade. The teeth also function to direct and stretch the longer hairs over the blade so they are cut more easily, avoiding the trapping and jamming of the blade by longer hairs that can occur with conventional face or leg shaving razors.

There is generally also a skin reference means behind the blade edge, which is often a portion of the razor cap. Other components of prep razors may include a covering of the blade intermittently with a thin foil to minimize the potential penetration of the blade into the skin. Additional components of prep razors also are found and will be familiar to those in the field, with similar objectives and benefits. Razors incorporating such components and variations are all encompassed by the terms “disposable hospital razor” or “prep razor” or similar designation, which terms are standard in the field and specific to such razors. All such razors are included in the scope of this invention, wherein the blade containing hair cutting member of the device, which is attached to one end of the device, comprises a prep razor. Prep razors are available from a number of medical manufacturers, including Dynarex™, Persona Medical™, and Derma-Safe™, as well as other manufacturers.

Prep razors are also designed to be used with the head of the razor contacting the skin at substantially a certain angle. This allows efficient cutting of hair without significant pressure of the blade against the skin. This preferred angle of contact may vary from manufacturer to manufacturer, and is always determinable for any given prep razor.

In addition to the use of mechanical prep razors, electric prep razors with similar functional and safety advantages in cutting longer body hairs safely also exist in the field. These electric prep razors may also be employed in preferred embodiments of the current invention.

The hair cutting member of personal grooming, electric hair cutting devices not intended for face shaving, also safely cut longer body hairs and do not require the use of hot water and lather. The blade containing electric hair cutting member of such personal grooming, hair cutting devices may also comprise the hair cutting member in preferred embodiments of the current invention Commercially available devices that incorporate such electric hair cutting components include the Micro-Touch Turbo™ and Just A Trim™. These products, however, do not enable or teach methods that enable unassisted removal of hair from an individual's back. These prior devices do not enable the user to reach most areas of the back for hair removal, and do not enable the user to position the hair cutting component in various ways behind the back necessary to comfortably and effectively remove hair from substantially all of the back area.

In addition, the electric cutting member blade of these prior devices is oriented in parallel to the long axis of the device, making the use of vertical stokes during the hair removal process essentially impossible for most of the back. As described below, when the arm is held behind the back when shaving the back, use of vertical strokes in an upward direction with the arm over the shoulders is much easier, safer and more effective than other approaches.

Importantly, therefore, neither currently available prep razors, nor personal grooming electric hair removal devices are themselves enabling for unassisted back hair removal.

It is an important aspect of the current invention to provide a device for shaving the back that enables establishing the proper angle for the head of the razor to contact the skin of the back during shaving, when the device is held behind the back, over the shoulders during shaving. This is accomplished by establishing the proper angle of the razor to the attachment means on the lower portion of the extension member of the device, in order to place the head of the razor at substantially the proper angle during use, when the device is placed over the shoulders, behind the back in a vertical position.

This can be accomplished either by permanently fixing the angle to which the razor attaches to the razor attachment means as appropriate for a given razor and only utilizing such given razor or known equivalent razor in the device; or by making the attachment means angle adjustable, so that it may be set by the user as appropriate for placing the razor head on the area of the back to be shaved. Both approaches are incorporated into embodiments of the current invention.

An effective, enabling device for removing hair from the back without assistance must also allow the individual to reach and shave all portions of the back comfortably for substantially all men within normal human height variation. In addition, when the hair cutting member is a mechanical (non-electric) razor, including but not limited to a prep razor, the device should preferably enable shaving of substantially all portions of the back using vertically oriented shaving strokes when the device is held behind the back, in order to maintain optimum comfort, consistency and safety during the shaving process.

Therefore, any device intended for back hair removal with a mechanical razor should permit substantially all men within normal human height variation to reach and shave substantially all portions of their back with vertical strokes to be enabling for safely shaving the back without assistance.

In addition, a back hair removal device that employs an electric hair cutting member must also allow substantially all men within normal human height variation to comfortably reach substantially all areas of the back, and position the hair cutting component appropriately, in order to effectively and conveniently remove hair from the entire back area. In addition it is also advantages for a back hair removal device that employs an electric hair cutting member to enable the user of the device to use primarily vertical oriented strokes for consistency and ease of use.

For this purpose, the blade of the electric hair cutting member should be capable of being oriented perpendicularly to the long axis of the device, so that the broad side of the blade will be in a proper position as the device is moved in a vertical direction up the back during the hair removal process. Preferred embodiments of the current invention incorporate this perpendicular orientation of the hair cutting member to the long axis of the device. Currently available electric personal hair grooming devices, such as those previously mentioned, do not, and utilize an electric blade component which is mounted and fixed in parallel or in-line with the long axis of the device.

An individual can normally place his hand comfortably behind his shoulders only approximately to the level of the bottom of the neck before experiencing some discomfort from stretching of the muscles of the arm, back and shoulder. Therefore, an enabling device for back hair removal should be long enough to reach the bottom portion of the back near the top of the hips and base of the spine when the hand is held over the shoulders behind the back and near the bottom of the neck. An individual whose height is within common, normal human variation can be accurately described as one whose height is within two standard deviations of the mean for the population. In the United States, the average male height is approximately 5″9″ with two standard deviations of about 5 inches and the average distance from the neck to the hips is approximately 23 inches, with two standard deviations of about 2-3 inches.

Therefore, unless a device is capable of being at least about 25 inches long at it longest measure, it will not enable shaving substantially all of the back for substantially all men of normal height variation. In addition, for removing hair from the area of the top of the back, the device should continue to allow one to use it comfortably when held by the handle.

The length of the device during such use should preferably be no greater than the height above the shoulders achieved when the device is held by the handle at a comfortable distance above the head of the individual and the hair cutting member end of the device is touching the shoulders, a distance of no greater than approximately 16 inches above the top of the shoulders for most individuals. Therefore, a device for enabling removing hair from the back should preferably be capable of achieving a minimum length of at most about 16 inches to comfortably shave the top of the back in most men. Preferably, a device for removing hair from the back without assistance should be variable in length within these two measurements of a maximum length of no less than about 25 inches an a minimum length of no greater than about 16 inches to permit achievement of both of these objectives and enable comfortable shaving using consistent technique for the entire back in most men.

An enabling device to permit unassisted back hair removal for most men should preferably be variable in length, be at least approximately 25 inches long at its longest length, and no more than approximately 16 inches long at its shortest length. Preferred embodiments of the current invention incorporate these objectives.

In addition, an enabling device for unassisted back hair removal for most men should preferably allow positioning of the device in various ways behind the back, and should allow adjustment of the angle of incidence of the extension piece to the back, as well as the angle of approach of the hair cutting member to the back, in order to permit the user to comfortably and effectively position the device for removing hair from different areas of the back.

As such, it is a first object of the present invention to allow an individual to safely remove hair from his back without assistant, with reduced risk of cutting and irritating the skin of the back.

It is another object of the present invention to provide a device and method that enable substantially all male individuals within normal human height variation to easily reach and remove hair from substantially all areas of their back without assistance from another person.

It is another object of the present invention to provide a back hair removal device and method that do not require the application of shaving cream, lather, or hot water to the back prior to hair removal for proper and effective use.

It is another object of the present invention to provide a back shaving device and method that do not require substantially increased pressure of the razor against the skin for shaving longer and thicker body hairs that are commonly found on the back of individuals.

It is another object of the present invention to provide a back shaving device, wherein the hair cutting member is a mechanical razor, that enables individuals of varying height to comfortably shave substantially all portions of their back without assistance using vertical shaving strokes, and does not require the use of horizontal or angled strokes for shaving certain areas of the back.

It is yet another object of the present invention to provide a device and method for removing back hair in privacy that can be used safely for substantially the entire back area for substantially all men within normal height variation.

It is another object of the present invention to provide a shaving device and method which assure that the razor head is positioned at a proper angle in relation to the skin for proper and effective function of the razor while shaving the back without assistance from another person.

It is yet another object of the present invention to provide an extendable device for removing hair from the back without assistance from another person, in which the handle of the device is not involved directly in the process of changing the length of the device, thereby permitting the handle to function independently and be set at different angles to the extension member of the device at various device lengths during back hair removal. This enables flexibility in positioning of the hand on the device and comfortable operation of the device during the hair removal process.

Accordingly, the present invention is a device and method for removing hair from the back without assistance from another individual.

In one embodiment, the device comprises a straight extension member, a handle engaged with the upper portion of the extension member, an attachment means at the lower end of the extension member for attaching a hair cutting member, and a hospital disposable razor, also known as a prep razor, attached to said attachment means.

The extension member, in one embodiment, is variable in length, and comprises at least two straight pieces that slide one within the other, locking in place at several points to establish several different lengths of the device. The extension member pieces do not pass into the handle during changing the length of device, but are instead engaged at a fixed point to the handle at the upper end of the extension member by an attachment means. Said attachment means is adjustable to permit varying the angle of engagement of the handle with the upper portion of the extension member.

The hair cutting member attached to the lower end of the extension member comprises a prep razor. Such razors are different from conventional face shaving razors and are specialized for cutting longer, thicker body hairs with reduced risk of irritating or cutting the skin. Several different manufacturers provide prep razors that can be incorporated in the device.

The device further comprises an attachment means at the lower end of the extension member, to attach and detach the prep razor. This attachment means is also designed to allow attachment to the prep razor handle at the correct angle to the extension member, so that when the device is held over the shoulder, behind the back, with the extension member in substantially a vertical position, that the head of the prep razor will contact the skin at the correct angle for effective use. The proper angle of skin contact for any prep razor is known and easily determined, allowing the angle of attachment of the prep razor handle to the attachment means at the lower portion of the extension member to be easily established. These two angles are in fact approximately the same for any prep razor with a straight handle.

In another embodiment, the device comprises a straight extension member, a handle engaged with the upper portion of the extension member, and a hair cutting member, which comprises an electric, personal grooming hair cutting member, engaged to the lower portion of the extension member.

In addition, in one preferred embodiment, the angle of the hair cutting member to the extension piece can be varied by the user, to permit the angle at which the head of the electric hair cutting member contacts the skin during hair removal to be varied, to enable easier and effective positioning of the hair cutting member head against the skin of the back as necessary for different areas of the back.

The angle of incidence of the head of the electric hair cutting member and the straight extension member is variable between 180 degrees and at least 90 degrees in either direction. The extension member, in one embodiment, comprises at least two straight pieces that slide one within the other, locking in place at several points to establish several different lengths of the device. The extension member pieces do not pass into the handle during changing the length of device, but are instead engaged at a fixed point to the handle at the upper end of the extension member by an attachment means. Said attachment means is adjustable to permit varying the angle of engagement of the handle with the upper portion of the extension member.

The device thereby incorporates a means for enabling the user to independently vary both the angle of engagement of the handle to the extension piece, and the angle of engagement of the hair cutting member to the extension piece. This enables the user to position the device in various ways behind the back, so that the device can be held comfortably while positioning the hair cutting member as needed to effectively remove hair from different areas of the back.

Through use of various angles of engagement of the handle and the hair cutting member to the extension piece, different configurations of the device are enabled. Some, though by no means all, examples of such different configurations are provided in the Figures.

In another embodiment of the device, the straight extension member is fixed in length, and at least two extension members of different length are provided to the user. The length of the device is changed by substituting extension members of different lengths in the device, which can be reversibly attached to the handle and hair cutting members of the device.

In another embodiment of the invention, the straight extension member is fixed in length and permanently attached to the handle, and at least two extension members of different length which are permanently attached to handles are provided to the user. The length of the device is changed by substituting extension members of different lengths in the device, which can be reversibly attached to the hair cutting member of the device.

The foregoing general description and the following detailed description are intended primarily for purposes of illustration. This invention may be embodied in other forms or carried out in other ways without departing from the scope of the invention. Modifications and variations still falling within the scope of the invention will be apparent to those skilled in the art.

### BRIEF DESCRIPTION OF THE DRAWINGS

The present invention can be best understood through the following description and accompanying drawings, wherein:

FIG. 1 illustrates a side view of a hair removal device, in accordance with one embodiment of the present invention;

FIG. 2 illustrates a side view of the hair removal device, in accordance with another embodiment of the present invention;

FIG. 3 illustrates a side view of a hair removal device with attached electric hair cutting member, in accordance with one embodiment of the present invention;

FIG. 4 is a close up view of the attached electric hair cutting member from FIG. 3, in accordance with one embodiment of the present invention;

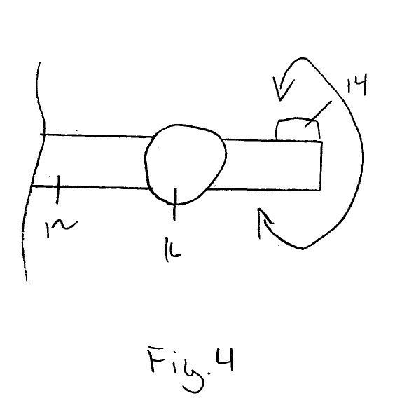

FIG. 5 is a cross section of the electric hair cutting member from FIG. 3, in accordance with one embodiment of the present invention; and

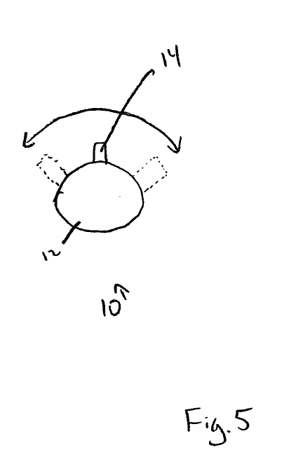

FIG. 6 is a multi-view diagram of the various positions of an adjustable hair removal device, in accordance with one embodiment of the present invention.

### DETAILED DESCRIPTION OF THE PREFERRED EMBODIMENTS

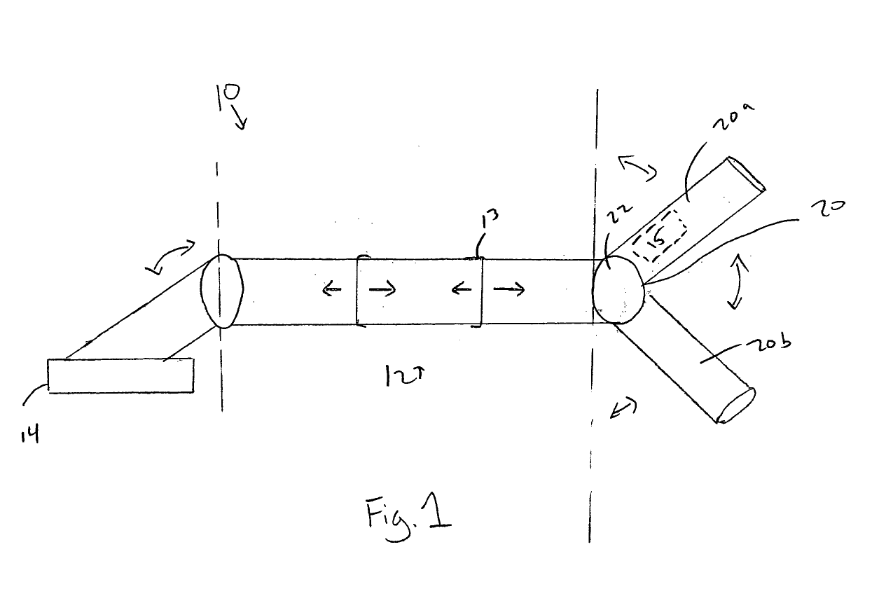

In accordance with one embodiment of the present invention, as illustrated in FIG. 1, a hair removal device 10 is disclosed. Device 10 comprises in combination, a straight extension member/extendable member 12, capable of varying in length between a shortest length of at most about 16 inches and a longest length of at least about 25 inches. Extension member 12 may be in the form of a two piece member having a center screw assembly 13 that allows for the two pieces to be set to a length and screw assembly 13 is then tightened.

A razor 14, such as a prep razor, electric prep razor or electric grooming device, attached to the lower end of the extendable member; an attachment means 16 at the lower end of extendable member 12 permitting the attachment and detachment of razor 14 to extendable member 12. It is understood that either an electric grooming device, electric prep razor or manual prep razor may be used in all of the following arrangements. It is noted that electric grooming devices refer to electric personal hair grooming devices used for hair removal such as the previously described Micro-Touch Turbo™ and Just A Trim™ tradename hair removal devices, but do not include electric facial hair shavers used typically for men's daily face shaving needs.

Preferably, razor 14, such as an electric grooming device maintains its hair removal/razor area perpendicular to the long axis of device 10, however the invention is not limited in this respect. Such an arrangement allows user to utilize a more stable up and down motion when shaving the desired area on the back as opposed to attachment of a standard razor type that would require a more unstable side to side moton.

Attachment means 16 preferably enables the adjustment of razor 14 at a various angles relative to extendable member 12, however a fixed angle attachment means 16 may also be used. A handle 20 about 5-10 inches in length, most preferably about 6-8 inches in length, attached to the upper end of extension member 12, into which handle 20 extendable member 12 does not pass when changing the length of the device 10. Handle 20, as illustrated in FIG. 1, may be composed of a bifurcated handle portions 20a and 20b which may be at a fixed angle with relation to one another, or may alternatively be independently adjustable relative to attachment member 22.

An attachment member 22 at the upper end of extendable member 12 that couples device handle 20 to extendable member 12 and permits handle 20 to be set at various angles relative to extendable member 12, however a fixed angle arrangement is also within the contemplation of the present invention.

In the case of electric prep razor or electric grooming device 14 an internal battery compartment 15 within either handle 20 or extendable straight member 12 may be used to supply an extended and to provide for extended shaving time and better balance in the device. However it is understood that standard electric grooming devices or prep razors 14 with internal batteries may be used as well.

In one embodiment of device 10, device handle 20 angle of attachment can be adjusted at least about 180 degrees in relation to the end of extendable member 12 to which it is attached, such that it can make a variable angle in either direction with respect to the end of extendable member 12. This permits the user to set a comfortable angle for holding handle 20 while having device 10 in a position for use behind the back. This adjustable angle can also be varied to more comfortably shave different parts of the back, in particular, different heights of the back. The length of handle 20, about 5-10 inches, also assists in comfortably placing the razor member 14 of device 10 against the skin of the back during device operation.

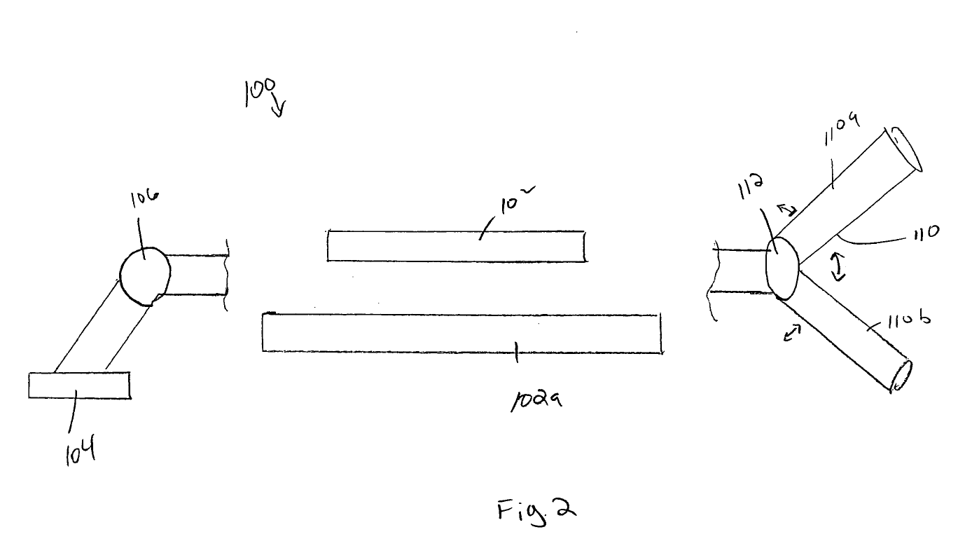

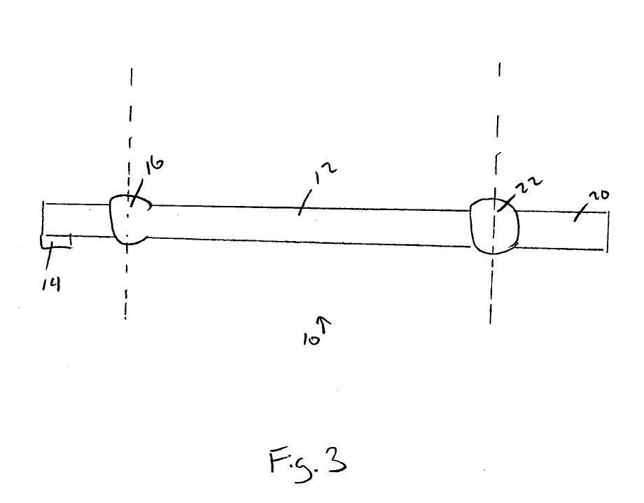

In accordance with another embodiment of the present invention, as illustrated in FIGS. 2 and 3, a hair removal device 100 is disclosed. Device 100 comprises in combination, a straight extension member 102 of fixed length between a short length of about 16 inches and a long length of about 25 inches. A razor 104 is attached to the lower end of straight member 102. An attachment means 106 is located at the lower end of straight member 102 permitting the attachment and detachment of razor 104 to straight member 102.

Attachment means 106 enables the setting of razor 104 at a various angles relative to straight member 102. A handle 110 of about 5-10 inches in length, most preferably about 6-8 inches in length, is attached to the upper end of straight member 102. An attachment means 112 at the upper end of straight member 102 that couples device handle 110 to straight member 102 and permits handle 110 to be set at various angles to straight member 102.

The length of device 100 can be varied by substituting different straight members 102, 102a . . . of different lengths between razor 104 and handle 110. In one embodiment of device 10, handle 110 angle of attachment can be adjusted at least about 180 degrees in relation to the end of extendable straight member 102 to which it is attached, such that it can make up to a variable angle in either direction with respect to the end of member 102. This permits the user to set a comfortable angle for holding handle 110 while having device 100 in a position for use behind the back. This adjustable angle can also be varied to more comfortably shave different parts of the back, in particular, different heights of the back. The length of handle 110, about 5-10 inches, also assists in comfortably placing the razor member 104 of device 100 against the skin of the back during device operation.

In one embodiment of the present invention, extendable straight member 12 or 102 is preferably 16 inches in total length at its shortest and 25 inches at its longest when measured from handle 20, 120 to razor 14, 104. Such a preferred length is configured to meet the full range of back shaving height requirements of men within two standard deviations in either direction of the average male height in the United States of 5′9″.

Additionally, the shorter height of substantially 16 inches means that device 10, 100 may be short enough for user to shave the upper back without the top of the device (handle 20, 120) extending upwards beyond their reach. Extendability to 25 inches is sufficient to reach the lower portions of the back while still being held at a comfortable position over the user's shoulders.

In accordance with one embodiment of the present invention, a method for shaving hair on the back is disclosed. For the purposes of illustration, device 10 from FIG. 1 is used to illustrate the salient features of the invention, but it is understood that device 110 from FIGS. 2 and 3 could be substituted.

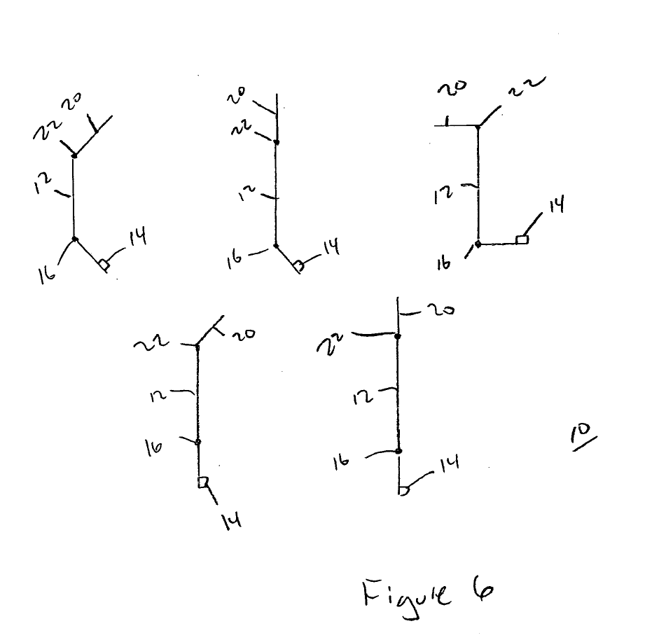

The method, as shown in the various views of FIG. 6, comprises the steps of providing a straight extendable member 12, capable of varying in length between a short length of about 16 inches and a long length of about 25 inches. A razor 14 is attached to the lower end of extendable member 12. An attachment means 16 is provided at the lower end of extendable member 12 permitting the attachment and detachment of razor 14 to extendable member 12.

Attachment means 16 enables the setting of razor 14 at a variable angle to extendable member 12. A handle 20 of about 5-10 inches in length is attached to the upper end of the extension member 12 into which handle 20 of extendable member 12 does not pass when changing the length of device 10.

An attachment means 22 at the upper end of extendable member 12 that couples the handle to the extendable member and permits the handle to be set at various angles to member 12. Handle 20 is held in one's hand, placing device 10 over the shoulders behind the back. Razor 14 is placed on an area of the back to be shaved, thus shaving the area. The length of extendable member 12 is adjusted, if necessary, to comfortably reach and shave other areas of the back; shaving any such additional areas.

In accordance with another embodiment of the present invention, device 10 includes straight extension member 12 that is capable of varying in length and a razor member 14 such as an electric grooming device, not intended for face shaving. Razor member 14 is attached to the lower end of extension member 12 and an attachment means 16 at the lower end of extension member 12. Attachment mean 16 enables the setting of hair cutting member 16 at a variable angle to extension member 12.

A handle 20 of about 5-10 inches in length, most preferably about 6-8 inches in length, is attached to the upper end of extension member 12, into which handle 20 extension member 12 does not pass when changing the length of device 10. Attachment means 22 at the upper end of extension member 12 that couples device 10 handle 20 to extension member 12 and permits handle 20 to be set at various angles to extension member 12.

In one embodiment of device 10, the angle of attachment of handle 20 can be adjusted at least about 180 degrees in relation to the end of extendable member 12 to which it is attached, such that it can make a variable angle in either direction with respect to the end of extendable member 12. This permits the user to set a comfortable angle for holding handle 20 while having device 10 in a position for use behind the back. This adjustable angle can also be varied to comfortably and effectively remove hair from different areas of the back. The length of handle 20, about 5-10 inches, also assists in comfortably placing hair cutting member 14 of device 10 against the skin of the back during device operation.

What is claimed is:

1. A device for removing hair from the back of an individual, said device comprising:
a substantially straight extension member;
a handle coupled to a first upper end of said straight extension member, said handle having an adjustable angle relative to said substantially straight extension member; and
an adjustable razor member coupled to said second lower end of said straight extension member, wherein said length of said substantially straight adjustable member is adjustable to a desired height on said back to be shaved, the angle of said handle relative to said substantially straight extension member is adjustable, and said razor is adjustable to a desired position to an appropriate angle for contacting the individuals back at said desired height.

2. The device as claimed in claimed in claim 1, wherein said substantially straight extension member is comprised of two pieces.

3. The device as claimed in claim 2, wherein said two pieces are adjusted to said desired length, and then are set by way of a screw assembly in the center of said substantially straight extension member.

4. The device as claimed in claim 1, wherein said substantially straight extension member is a single piece, wherein the height is adjusted by substituting a substantially straight member of a different length.

5. The device as claimed in claim 1, wherein said handle is attached to said substantially straight extension member by an adjustable attachment member that allows said handle to rotate relative to said substantially straight extension member.

6. The device as claimed in claim 5, wherein said handle coupled to said adjustable attachment member is composed of two portions, said portions being at a fixed angle relative to one another.

7. The device as claimed in claim 5, wherein said handle coupled to said adjustable attachment member is composed of two portions, said portions being moveable relative to one another.

8. The device as claimed in claim 1, wherein said razor is selected from the group consisting of prep razors, electric grooming devices and electric prep razors.

9. The device as claimed in claim 8, wherein said electric razor maintains a grooming surface that is perpendicular to the long axis of said device for removing hair, allowing a user to shave with an up and down motion of their arm.

10. The device as claimed in claim 1, wherein said handle maintains a battery compartment for said razor member.

11. A device for removing hair from the back of an individual, said device comprising:
a substantially straight extendable member;
a handle coupled to a first upper end of said straight extendable member, said handle having an adjustable angle relative to said substantially straight extendable member; and
an adjustable razor member coupled to said second lower end of said straight extendable member, wherein said length of said device from said handle to said razor member is substantially in the range of 16 inches to 25 inches, adjustable within this range to a desired height on said back to be shaved, the angle of said handle relative to said substantially straight extendable member is adjustable, and said razor is adjustable to a desired position to an appropriate angle for contacting the individuals back at said desired height.

12. A device for removing hair from the back of an individual, said device comprising:
a substantially straight member;
a handle coupled to a first upper end of said straight member; and
a razor member coupled to a second lower end of said straight member, wherein said razor member is selected from the group consisting of manual prep razors, electric prep razors and electric hair grooming devices.

13. The device as claimed in claim 12, wherein said electric razor maintains a grooming surface that is perpendicular to the long axis of said device for removing hair, allowing a user to shave with an up and down motion of their arm.

14. A method for removing hair from the body, said method comprising the steps of:
setting an extendable straight member of a shaving device to a desired height;
setting a handle, attached to said straight member to a desired angle; and
setting a razor to a desired angle relative to said straight member, wherein said razor is selected from the group consisting of manual prep razors, electric prep razors and electric hair grooming devices.

15. The method as claimed in claim 14, wherein said extendable member is adjusted in height by replacing a first member of a fixed length with a second member of different fixed length.

16. The method as claimed in claim 14, further comprising the step of adjusting the angle of said handle relative to said extendable member.

17. The method as claimed in claim 14, further comprising the step of adjusting the height of said shaving device where the length of said device from said handle to said razor member is substantially in the range of 16 inches to 25 inches.
